(19) United States
(12) Patent Application Publication
(10) Pub. No.: US 2024/0146828 A1
(43) Pub. Date: May 2, 2024

(54) REVERSE FORWARDED CONNECTIONS

(71) Applicant: GM Cruise Holdings LLC, San Francisco, CA (US)

(72) Inventors: Stephen James Day, Kirkland, WA (US); Bianca Tamayo, San Francisco, CA (US); Ian Robert Chiles, Charleston, SC (US); Akhil Acharya, Cambridge, MA (US)

(21) Appl. No.: 17/979,708

(22) Filed: Nov. 2, 2022

(51) Int. Cl. G06F 9/4401; G06F 9/54

(52) U.S. Cl. CPC G06F 9/4416; G06F 9/4406; G06F 9/547

(57) ABSTRACT

The present disclosure may use reverse forwarded socket connections and rules to manage program code that is being developed. Each developer responsible for developing program code may be provided unique login information that they may use to access data associated with a development environment. Validations of a user/developer and/or computer identity may be performed before a user is allowed to access and update sets of program code. Reverse forwarded socket connections may be associated with endpoints at a remote computer. Once a particular connection is established and a validation performed, identifiers may be used to direct communications to processes, sub-processes, virtual machines, or specific computing resources that are associated with the development environment. By using reverse forwarded socket connections, computers that run different types of operating system software may be used to develop program code without having to install specialized software on those computers.

### BACKGROUND

### 1. Technical Field

The present disclosure generally relates to solutions for providing access to local computer resources from one or more remote systems and in particular, for using reverse forwarded connections to enable remote system access to data on a local file system when sets of program code are developed.

### 2. Introduction

Over the years many different forms of processors and operating systems (OS) software have been developed by different companies and individuals. Examples of specific types of OS software available today include Apple Macintosh OS, Microsoft Windows OS, and Linux OS software. Since the outbreak of the Coronavirus (COVID-19) pandemic, individuals began working more and more at remote locations. This working at home trend has led to some organizations allowing their employees to work at home all of the time. Since these companies often have data that must be accessed such that their workers can perform their job, the number of computer programs that allow workers to perform their jobs has grown dramatically. Computer programs like Skype and Zoom allow workers to conduct phone calls or have video meetings nearly anywhere in the world via their computers. Since different workers that work for a same company use computers that run different types of OS software, some kind of application program is typically installed on the computers of these workers. Since it is unlikely that this working at home trend will stop anytime soon, new methods will be developed to make the process of working remotely more convenient.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates a local computer that is configured to manage data for several remote computers, according to some examples of the present disclosure.

FIG. 2 illustrates a flowchart of an example process that may be performed by a processor of a local computer that allows a user to develop program code using data from a remote computer.

FIG. 3 illustrates a flowchart of an example process that may be performed at a local computer for authenticating a user and/or a remote device, according to some examples of the present disclosure.

FIG. 4 illustrates a flowchart of an example process that may be performed at a local computer for managing multiple development environments.

FIG. 5 illustrates a flowchart of an example process that may be performed by a local computer that manages data for a remote computer, according to some examples of the present disclosure.

FIG. 6 illustrates an example processor-based system with which some aspects of the subject technology can be implemented, according to some aspects of the disclosed technology.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

Some aspects of the disclosed technology may include the gathering and use of data available from various sources to improve quality and experience. The present disclosure contemplates that in some instances, this gathered data may include personal information. The present disclosure contemplates that the entities involved with such personal information respect and value privacy policies and practices.

One challenge in utilizing remote computing systems for performing tasks that require local system access, such as running integrated development environments (IDEs), is that specialized connectivity software may be needed for the remote system to gain local file-system access. In situations where multiple remote systems are running different operating systems, multiple versions of the connectivity software may need to be installed.

Aspects of the present disclosure provides solutions for allowing remote computers to access and manipulate files on a local file system without having to generate and maintain communication software at the remote computers. This local computer may be a desktop computer, a laptop computer, a server, or other type of computing device. The remote computer(s) may be any type of computer that can be coupled to the local computer using methods that may use a reverse forwarded socket connection. This local computer may manage communication sessions, where each session allows one or more remote computers to access and modify files on the local computer. By way of example, the remote computer may access and update sets of data or program code, including accessing data stored on a file system of the local computer or accessing and updating files stored at the local computer. A local computer operated by a single user may be the only computer that is allowed to access certain data or update particular software programs or files based on a particular user being authorized to access and update data stored at the remote computer. In certain instances, a developer may be the only individual authorized to access program code that is associated with their own development environment. One user/developer may be able to access data that belongs to multiple development environments assigned to that user/developer. While in certain instances, only a single developer may be allowed to update program code sets associated with a particular user or development environment, administrators may be allowed to intervene according to rules used to manage sets of software.

The present disclosure may use reverse forwarded socket connections and rules to manage program code that is being developed. Each developer responsible for developing program code may be provided unique login information that they may use to access data associated with a development environment. Validations of a user/developer and/or computer identity may be performed before a user is allowed to access and update sets of program code. Reverse forwarded socket connections may be associated with endpoints at a remote computer. Such endpoints may be associated with a port of a remote computer when transmission control protocol-Internet protocol (TCPIP) communications are used or may be associated with a filename or Unix socket. Once a particular connection is established and a validation performed, identifiers may be used to direct communications to processes, sub-processes, virtual machines, or specific computing resources that are associated with the development environment. By using reverse forwarded socket connections, computers that run different types of operating system software may be used to develop program code without having to install specialized software on those computers. Such reverse forwarded socket connections may also be referred to as reverse forwarded binding of resources located at a remote computer with resources located at a local computer. The local computer may also limit resources that a remote computer can access based on access rules or capabilities of the local computer. A reverse forward socket connection allows computers to communicate directly with a computer even when one of those computers is located behind a firewall. Reverse forwarded socket connections allow a local computer to communicate with a remote computer by the local computer sending, for example, a secure shell (SSH) communication to the remote computer via a first connection. At this time the remote computer may be listening or be prepared to receive communications via a communication interface or port at the remote computer, this may include the remote computer opening an SSH connection capable of receiving communications from local computers. This is true even when the remote computer is located behind a firewall. Once the remote computer receives a communication from the local computer, the remote computer may then form a second connection with the local computer that allows the remote computer to access, copy/upload, change, erase, download, or manipulate data (potentially including file system data) stored at the local computer. This second connection may be a secure communication tunnel. The local computer may also be able to access data at the remote computer. The local computer may initially communicate with the remote computer using the first communication connection by entering commands into a command line interface associated with the first communication connection. Later after the second communication connection is formed, a user of the local computer may provide commands to a command line interface associated with the second communication connection. Commands received from the local computer via the second communication connection may result in the remote computer sending data to the local computer, retrieving data from the local computer, or otherwise manipulating data stored at or accessible by the local computer. From perspective of a user of the local computer, the command line interface associated with the first connection and the command line interface associated with the second connection may appear to be the same command line interface. It may also appear to the user of the local computer that all tasks performed are performed by the local computer even when at least some or most of those tasks are not performed by the local computer.

The present disclosure may use reverse forwarded socket connections and rules to enable access by a remote system to various resources on a local computer. By way of example, access of the local computer may include provisioning access to the local file system for the purpose of managing program code that is being developed within an internal development environment (IDE) of the local computer. Each developer responsible for developing program code may be provided unique login information that they may use to access one or more remote computers that also may store data associated with a development environment. Validations of a user/developer and/or computer identity may be performed before access to sets of program code or related data are allowed. As mentioned above, reverse forwarded socket connections may be associated with a port of a remote computer in instances when TCPIP is used or may be associated with a filename when a Unix socket is used. Once a particular connection is established and a validation performed, port identifiers or filenames may be used to direct communications to processes, sub-processes, virtual machines, or specific computing resources that are associated with the development environment of the developer. By using reverse forwarded socket connections, computers that run different types of operating system software may be used to develop program code without having to install specialized software on those computers.

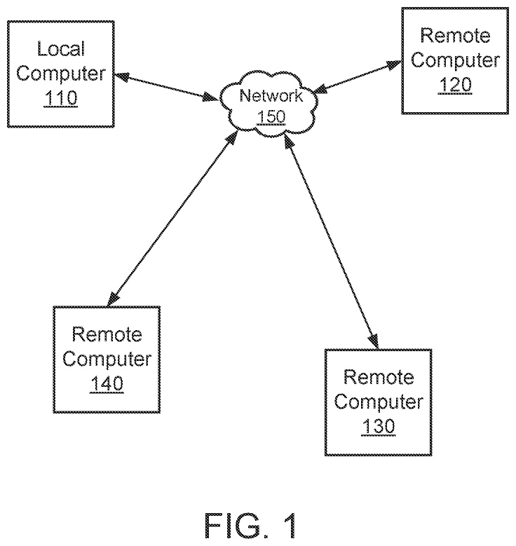

FIG. 1 illustrates a local computer that manages data for several remote computers. FIG. 1 includes local computer 110 and remote computers 120, 130, and 140. Local computer 110 may be a computer that is configured to manage one or more sets of program code that are being developed by a developer using communications sent over computer network or interconnect 150. Network or interconnect 150 may include any form of communication coupling between computers, such as a cable, corporate network, or the Internet. Remote computers 120, 130, and 140 may be physical computers or be virtual computers implemented within one or more physical computers. These remote computers may store information that may be used by local computer 110 when a user of local computer 110 develops program code. Each remote computer of FIG. 1 may be provided with one or more of its own development environments or with information that supports development environments implemented at local computer 110. A single developer may be able to access data associated with a first file in a first development environment and access data associated with a second development environment. For example, developer Max may be responsible for developing program code that allows a processor to make determinations based on received sensor data and Max may also be responsible for developing test programs that test the program code that makes the determinations based on the received sensor data. Each of these different types of program code may be associated with its own development environment. Each of these two different development environments may be separate from each other, yet each may be accessible by a computer (e.g., local computer 110) that belongs to developer Max.

In certain instances, local computer 110 may establish a development environment for each remote computer. Each of the remote computers 120, 130, and 140 may respectively include different types of processors that execute different type of operating system (OS) code. For example, remote computer 120 may be an Apple Macintosh computer running a version of MAC OS software, remote computer 130 may be a personal computer running a version of Microsoft Windows OS software, and remote computer 140 may be an ARM computer running a version of Unix or Linux OS software. Methods of the present disclosure, therefore, allow a truly heterogenous computing development system to operate without need for compiling software to execute on different types of computers. The term heterogenous computing system means that computer that use different types of processors and/or operating system software work together. The term homogenous computing system refers to computers that use the same type of processor and/or same type of operating system software that work together.

Local computer 110 may connect to a remote computer (e.g., any of remote computers 12, 130, or 140) using a first connection and this may result in the remote computer forming a reverse forwarded socket connection with local computer 110. In some instances, a reverse forwarded socket connection can be established between the local computer and a remote computer when an internet protocol (IP) address of the remote computer and a port number are input into a command line at the local computer. This process may include assigning a socket at the remote computer 120 that listens for incoming communications from the local computer 110. When a connection is made to remote computer 120 from local computer 110, the connection may be forwarded over a secure channel by remote computer 120 when a reverse forwarded socket connection is made between remote computer 120 and local computer 110. As mentioned above, instead of using a port number, a filename may be identified from information received in a communication received by the remote computer to bind resources of the two computers 110 and 120 together. This reverse forwarded socket connection may allow the remote computer to access and/or update data stored at the local computer and may allow a user of local computer 110 to access resources of remote computer 120.

In an example, the secure shell (SSH) protocol may be used in order to establish communications with a remote computer located behind a firewall and reverse SSH port forwarding may be used to bypass operations of the firewall. The remote computer may open an SSH connection to the outside world and include a −R tunnel that has an entry point that is capable of receiving communications from other computers, such as local computer 110. A communication received from local computer 110 may be forwarded to an SSH port on remote computer 120. This could include local computer 110 sending the command:

**ssh-R 2210:localhost:22 username@Remote.com

This command will initiate an SSH connection with reverse port forwarding option which will then open listening port 2210: that is going to be forwarded back to localhost's port: 22 and all this will happen on the remote computer username@Remote.com. The −R option tells the tunnel to answer on the remote side, which may be an SSH server and the −L option tells the tunnel to answer on the local computer side of the tunnel. Other commands may also be used.

Other options that could be added to a command may include:
**ssh −f −N −T −R 2210:localhost:22 username@yourMachine.com
**ssh −f: tells the SSH to background itself after it authenticates, saving you time by not having to run something on the remote server for the tunnel to remain alive.
**ssh −n: if all you need is to create a tunnel without running any remote commands then include this option to save resources.
**ssh −t: useful to disable pseudo-tty allocation, which is fitting if you are not trying to create an interactive shell.
**ssh −p 2210 username@localhost; This may seem like performing an SSH on localhost, instead your request may be forwarded to the remote host. This command may establish a connection to the firewall host through the tunnel.

By using reverse forwarded socket connections, no additional or special software need be deployed or installed on the remote computers (120, 130, and/or 140) for communication with local computer 110. When local computer 110 is configured to establish a program development environment using reverse forwarded socket connections, commands entered into a command line interface at remote computer 120 may be used to modify program code that is part of the development environment that is dedicated to a user of local computer 110. In certain instances, both local computer 110 and remote computer 120 may each have their own respective command line interface. A first command line interface at computer 110 may allow a user of the local computer to enter data that initiates the process that results in the setting up a reverse forwarded socket connection. A second command line interface may be located at remote computer 120 may be accessed by local computer 110 after the reverse forwarded socket connection is formed. This second command line interface may be used by a user of local computer 110 to identify data that remote computer 120 should send to local computer 110. Remote computer may then access files at local computer 110 when updating or backing up data stored at local computer 110.

The use of reverse forwarded socket connections to manage data eliminates the need for compiling and deploying specialized communications/networking software on different computers. This allows those computers to work with each other without the need to develop or maintain special communication programs at remote or local computers. In some instances, development systems that are shared by different developers use homogenous types of computers systems and software because only one set of software need be developed to allow computers of those developers to update sets of program code. In other instances, development systems that support multiple different types of computers and/or OS software require different sets of software to be developed to run on each respective type of computer and or set of OS software. By using reverse forwarded socket connections, methods of the present disclosure use heterogenous computers and software that work together without need to compile and deploy specialized sets of software on each respective local and/or remote computer.

Functions that may be performed by a remote computer include opening files, sending notifications and provisioning other development environments. In a first instance, a user of the local computer may enter information into a command line interface at the local computer indicating that code residing at the remote computer should be used to initiate operation of a development environment. The command may then be received by the remote computer and then a reverse forwarded socket connection may be established between the remote computer and the local computer. The remote computer may then send data and a command to the local computer that results in the development environment being generated at the local computer. In a second instance, when the reverse forwarded socket connection has already been established between the remote computer and the local computer, a user of the local computer may provide the command to initiate operation of the development environment via a command line interface that resides at the remote computer. In this second instance, the command sent to the remote computer may be sent using the already established reverse forwarded socket connection. In the first instance, the command may be sent via an initial connection and in the second instance, the command may be sent via the reverse forwarded socket connection. In either instance, the outcome may result in the same development environment being established.

In yet other instances, a user may have already provisioned a first development environment using communications with a remote computer and when that user wishes to provision a second development environment, the remote computer may send a command to the local computer that backs up data associated with the first development environment. This may be performed based on a rule that dictates when a remote computer should backup data located at a local computer. Such rules may allow the remote computer to keep copies of program code that are essential to a development environment and may allow for a minimal amount of data to permanently reside at the local computer. When the user wishes to generate a second development environment, the user may send a command from the local computer via a command line interface that resides at the remote computer. This command may result in the remote computer storing data at the local computer via the reverse forwarded socket connection such that the second development environment may be instantiated at the local computer. A user of the local computer may send an additional command via the command line interface at the remote computer that results in switching from the second development environment to the first development environment.

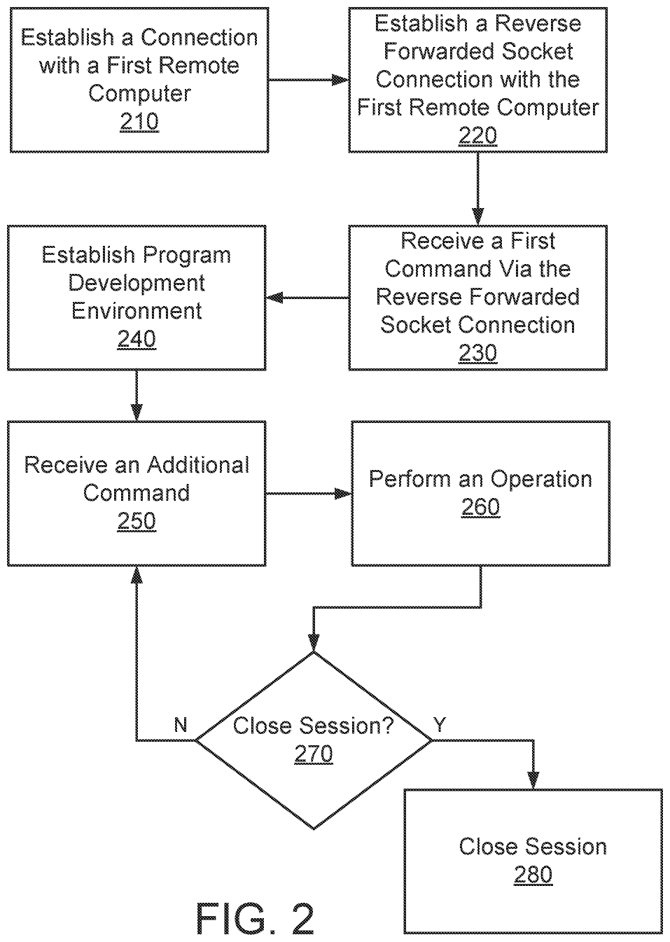

FIG. 2 illustrates a flowchart of an example process that may be performed by a processor of a local computer that allows a user to develop program code using data from a remote computer. As mentioned above, an IP address and port number (or alternatively a filename or Unix socket identifier) input into a command line interface of the local computer allows the local computer to connect to a remote computer at block 210 such that a reverse forward socket connection can be formed between the remote computer and the local computer at block 220. This may include the local computer instructing the remote computer to bind a local computer at block 210. A command may be sent from the local computer to the remote computer at block 210. This may be referred to as establishing a connection with the first remote computer or sending a communication to the first remote computer based on the first computer being capable of receiving communications from local computers. This may allow clients or processes on the remote computer to connect back to a service running on the local computer at block 220. For example, the local computer may send a filename to the remote computer and this filename may be used by the remote computer to provision data onto the local computer based on the filename. In other instances, the local computer may send a communication to the remote computer that identifies an Internet protocol (IP) address of the remote computer and a port number of the remote computer. The remote computer may then establish the reverse forwarded connection with the local computer, for example, using the port identified in the communication sent from the local computer to the remote computer. This process may also be described as the local computer sending information to the remote computer that instructs the remote computer to create a communication tunnel with the local computer.

Any communications received from or sent to a particular remote computer may be associated different types of identifiers, as mentioned above a port number, a filename, or other identifiers may be used to bind the remote computer to the local computer. Port identifiers may be used by the local computer to identify which particular remote computer sent a communication to the local computer. While not illustrated in FIG. 2, methods of the present disclosure may also require authentication of a user, remote computer, or both before the remote computer is allowed to access data or resources at the local computer or visa versa. Here again, the local computer may manage data associated with a development environment of a particular user.

Block 230 of FIG. 2 is where a first command may be received at the local computer with the reverse forwarded socket connection. This first command may be received after the successful completion of an authentication or validation process. This first command may instruct the local computer to instantiate a program development environment that is associated with the remote computer in response to the first command. This may include opening an existing program development environment or instructing the local computer to create a new program development environment. Data may be stored at the local computer that was provided by the remote computer and this data may allow the program development environment to be instantiated at the local computer.

The first command may be sent from the remote computer in response to information received from the local computer over the reverse forwarded connection. The remote computer may send data to the local computer that allows the local computer to establish the program development environment in block 240. The program development environment may allow a user/developer to access sets of program code that the user is developing, may allow a user of the local computer to use a text editor or see a graphical user interface (GUI) associated with controlling the remote computer. This user may make updates to sets of program code that they are responsible for developing. This means that a user may open a set of program code, make updates to that set of program code, execute that set of program code, and save program code updates based on commands received from a particular remote computer via the reverse forwarded socket connection. These operations may appear to occur only at the local device, yet a number of these operations would occur at the remote computer.

The remote computer may not include a display monitor and, therefore, may be a “headless” computer (a computer without a monitor). The remote computer may provide a graphical user interface (GUI) to the local computer via the reverse forwarded socket connection, and a user of the local computer may interact with this GUI as if the GUI were located at the local computer. Files located at the remote computer may be mapped with files located at the local computer. When a development environment is opened, the remote computer may provide data to the local computer based on such a file mapping. Once the development environment is opened, a user of the local computer may update program code that resides at the local computer. When the development environment is closed, data—including any updates—may be sent back to the remote computer for storage. Alternatively, all program code may reside at the remote computer and the local computer may receive data from the remote computer may be displayed on a display of the local computer as if the program code is stored at the local computer.

An additional or second command may be received from the remote computer at block 250. An operation may be performed at the local computer after the local computer receives the second command. This operation performed at the local computer may include accessing data, updating data, modifying file system data of the local computer, providing feedback regarding GUI entries made by a user, or may result in data being sent from the local computer to the remote computer. After the command is received at block 250, an operation associated with that command may be performed at block 260 according to the command. Such an operation may include any operation allowed by the local computer, including yet not limited to opening a text editor, accessing a GUI of the remote computer, establishing a second development environment, updating data, executing code, or saving of sets of program code.

Determination block 270 may identify whether the communication session with the remote computer should be closed. When the communication session should not be closed, program flow may move back to block 250 where another additional command is received from the remote computer. Here again, each additional command may be associated with opening a text editor, accessing a GUI of the remote computer, establishing a second development environment, updating data, executing code, or saving of sets of program code. When determination block 270 identifies that the communication session should be closed, program flow may move to block 280 where the communication session is closed. The closing of a communication session may automatically result in data located at the local computer being retrieved by the remote computer as a backup function.

Any updates to the sets of program code associated with a particular user and/or remote device may be stored in block 280. At a later point in time, the user may establish a new reverse forwarded socket connection and the blocks of FIG. 2 may be repeated as the user continues to develop their sets of program code. Stored state information may be used to restore a particular development environment to a previous state. This state information may allow a user to pick up working at a point where they stopped working. For example, a file that a developer was working on in a previous session that was closed earlier may be opened automatically when the user initiates a new development session. In such an instance, the state information may identify a page of a file and that page may be displayed on a display of the local computer and a user of the local computer may be allowed to edit content of that page using a text editor.

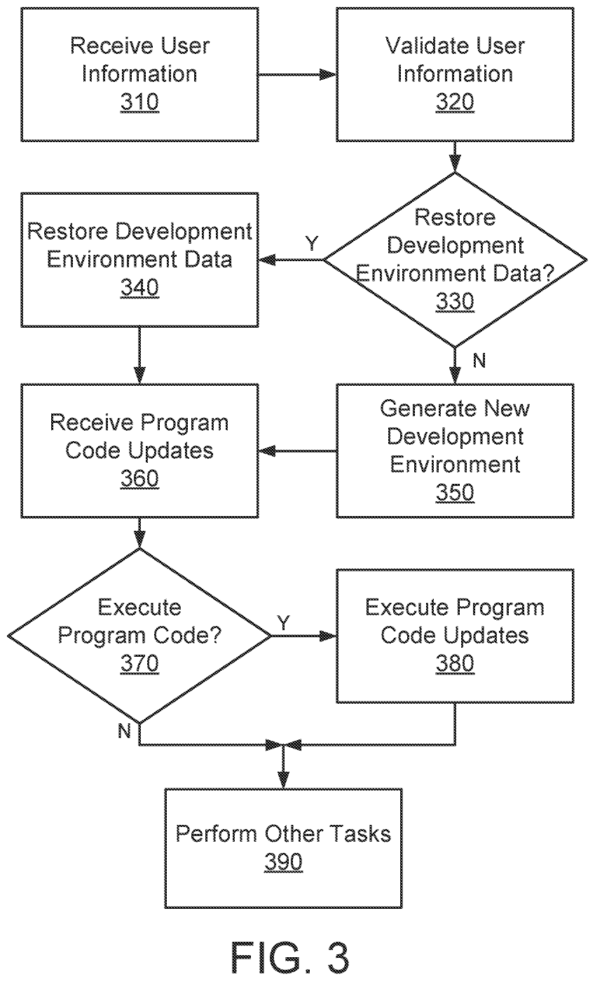

FIG. 3 illustrates a flowchart of an example process that may be performed at a local computer when the local computer authenticates a user and/or remote device. User information may be received in block 310. That user information may be validated in block 320. This user information may include a password, a user identifier, and/or information that uniquely identifies the remote computer (e.g., a machine identifier). Determination block 330 may identify whether a previous development environment should be restored. When the previous development environments should be restored, that previous development environment may be restored in block 340. The restoration of the previous development environment may include accessing state data associated with a previous communication session. This state data may identify program code sets that were previously worked on by the user and a processor of the local computer may restore the state of a previous development session such that the user can start working where they left off. This could include opening a set of code in an editor at the local computer.

When determination block 330 identifies that a development environment should not be restored, program flow may move to block 350 where a new development environment is generated. This new program development environment may be setup by a user identifying sets of program code that should be included in their personal program development environment. For example, a user may select a program code set from a repository accessible by the local computer and that selected code set may be placed into the user's development environment based on a command received via a reverse forwarded socket connection.

Program code updates may be received in block 360. Determination block 370 may identify whether the updated set of program code should be executed. When determination block 370 identifies that the program code updates should be executed, software that includes the program code updates may be executed in block 380. This may include executing a set of simulation software or test software at the local computer. This user may, therefore, be able to validate whether their program code updates achieved a desired result. Either after block 380 or when determination block 370 identifies that the program code should not be executed, program flow may move to block 390 where other tasks may be performed. These other tasks may include saving updated sets of program code, saving state information associated with the updated sets of program code, or may include executing other commands received from a remote computer. The blocks of FIG. 3 may be performed in conjunction with the blocks of FIG. 2 by a processor of a local computer such as local computer 110 of FIG. 1.

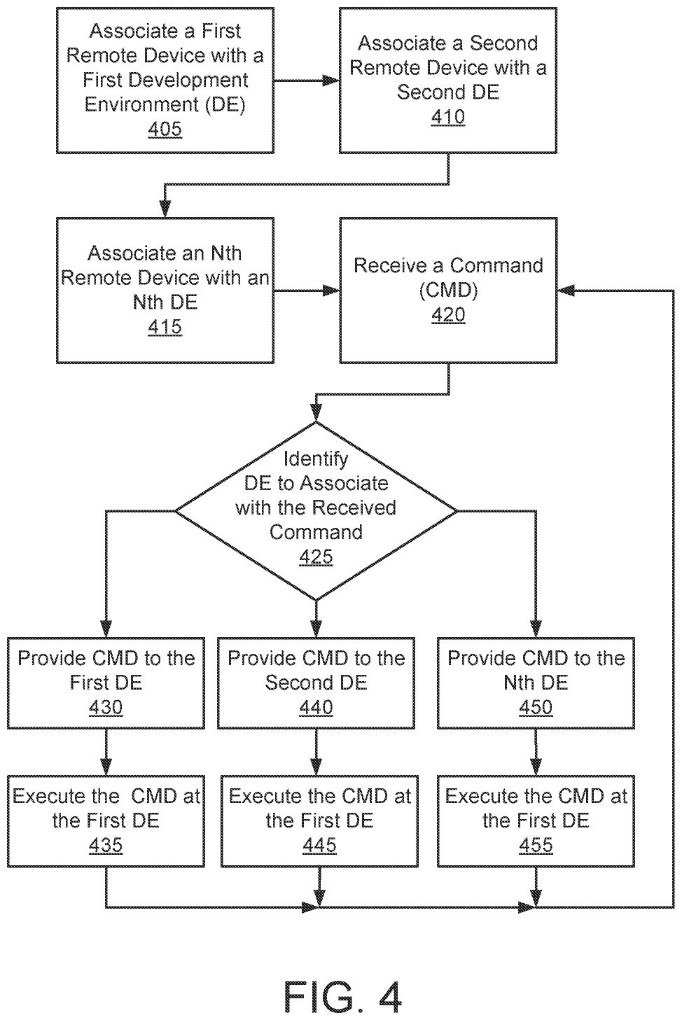

FIG. 4 illustrates a flowchart of an example process that may be performed at a local computer when that local computer manages data for multiple different development environments. FIG. 4 includes block 405 where a first remote device may be associated with a first integrated development environment (IDE). A second remote device may be associated with a second development environment at block 410. An Nth remote device may be associated with an Nth development environment. A command may be received at block 420. Determination block 425 may identify a development environment to which the received command should be provided. This identification may be made based on a port number, filename, or Unix socket identifier received with or that is associated with the received command. Depending on which development environment the command is associated with, program flow may move from block 425 to either block 430, 440, or 450. Block 430 may be performed when the command is associated with the first development environment, block 440 may be performed when the command is associated with the second development environment, and block 450 may be performed when the command is associated with the Nth development environment. Determination block 425, thus, routes received commands to appropriate resources based on port associations.

When the command is associated with the first development environment, that command may be provided to the first development environment at block 430 and then that command may be executed in block 435. When the command is associated with the second development environment, that command may be provided to the second development environment at block 440 and then that command may be executed in block 445. When the command is associated with the Nth development environment, that command may be provided to the Nth development environment at block 450 and then that command may be executed in block 455. After the command is executed in either of blocks 435, 445, or 455, program flow may move back to block 415 where an additional command may be received. When a command instructs the local computer to close a development environment, state information associated with that development environment may be saved and the local computer may continue performing operations associated with the other development environments. While not illustrated in FIG. 4, a local computer may perform functions relating to creating new development environments, restoring previous development environments, or closing a development environment.

In instances when the local computer includes multiple processors, certain development environments may be associated with certain specific processor of those multiple processors. Routers may also be used to route communications to specific physical or virtual machines that perform functions consistent with those discussed herein that the local computer performs. This could allow for increasing a number of development environments that a system consistent with the present disclosure can support and may allow the system to perform optimally.

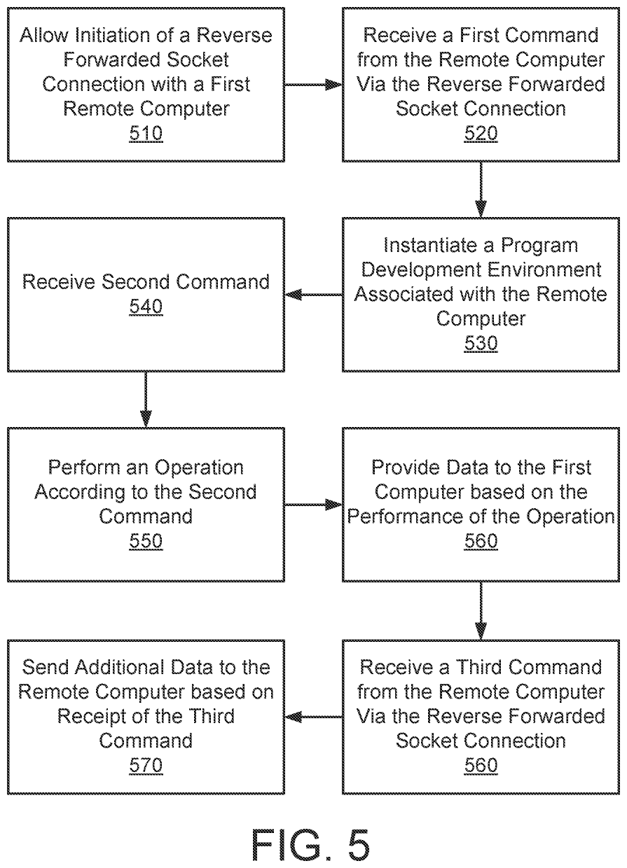

FIG. 5 illustrates a flowchart of an example process that may be performed by a local computer that manages data for a remote computer, according to some examples of the present disclosure. The various commands received, and operations performed in the blocks of FIG. 5 may be similar or identical to command and operations discussed in respect to FIGS. 2-4. The local computer may allow the initiation of a reverse forwarded socket connection with a first computer at block 510 of FIG. 5 as discussed in respect to FIG. 2. The local computer may also receive a first command from the remote computer via the reverse forwarded socket connection in block 520. A program development environment associated with the remote computer or a user of the remote computer may be instantiated at block 530 in response to the first command. A second command may be received block 540. An operation may be performed according to the second command in block 550. As discussed above, the first and second command may be associated with opening a text editor, accessing a GUI of the remote computer, establishing a second development environment, updating data, executing code, or saving of sets of program code. The local computer may provide data to the first computer based on performing the second command in block 560. A third command may be received at block 560. Additional data may be sent to the remote computer based on receiving the third command in block 570.

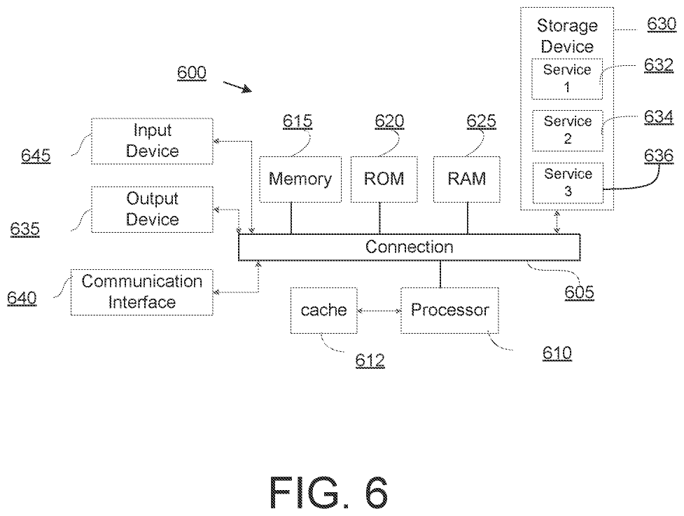

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing the methods disclosed herein. The particular sequence of such executable instructions or associated data structures represents examples of corresponding acts for implementing the functions described in the present disclosure. In certain instances, operations performed in blocks of the flow charts of FIGS. 2-5 may be optional or may be performed in a different order than illustrated in FIGS. 2-5.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include various aspects:

Aspects of then invention include methods and apparatus that manage software sets that are being developed by different developers of a development organization. A method of the present disclosure may include sending a communication from a local computer to a first remote computer via a first communication connection, establishing a reverse forwarded socket connection with the first remote computer based on data received from the first remote computer in response to the first remote computer receiving the communication from the local computer, receiving a first command that was sent from the first remote computer via the reverse forwarded socket connection, instantiating a program development environment associated with the first remote computer, in response to the first command, and receiving a second command associated with the program development environment via the reverse forwarded socket connection. This second command may be received from the first remote computer. This method may also include performing an operation according to the second command and providing data to the first remote computer based on the performance of the operation.

Actions by a local computing device may be based on commands received from remote computing device. The reverse forwarded socket connection may be associated with an endpoint at the remote computer and these connections may be formed based on a first port of the local computing device, a filename, or a Unix socket identifier.

These methods may be performed as non-transitory computer-readable storage medium where a processor that executes instructions out of a memory. Apparatus consistent with the present disclosure may include a memory and a processor that executes instructions out of the memory to perform methods discussed herein.

These methods may also include receiving a third command via the reverse forwarded socket connection associated with accessing with file system data of the local computing device and sending the file system data to the first remote computer via the reverse forwarded socket connection based on receiving the third command.

In certain instances, this method may include receiving by the local computing device a third command that was sent from a second remote computer via a second reverse forwarded socket connection that binds the local computing device to the second remote computer, establishing a second program development environment uniquely associated with the second remote computer, receiving a fourth command associated with the second program development environment via the second reverse forwarded socket connection, executing the second command at the local computing device, and providing data to the second remote computer based on the execution of the second command. In certain instances, the first remote computer may execute instructions of a first type of operating system and the second computer may execute instructions of a second type of operating system.

The reverse forwarded socket connection connections may have been established without provisioning the first remote computer or possibly the local computer with program code configured to allow the first remote computer to send the first command and the second command to the local computing device. Furthermore, the second reverse forwarded socket connection may have been established without provisioning the second remote computer with the program code configured to allow the second computer to send the third command and the fourth command to the local computing device.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
sending a communication from a local computer to a first remote computer via a first communication connection;
establishing a reverse forwarded socket connection with the first remote computer based on data received from the first remote computer in response to the first remote computer receiving the communication from the local computer;
receiving a first command that was sent from the first remote computer via the reverse forwarded socket connection;
instantiating a program development environment associated with the first remote computer, in response to the first command;
receiving a second command associated with the program development environment via the reverse forwarded socket connection, the second command received from the first remote computer;
performing an operation according to the second command; and
providing data to the first remote computer based on the performance of the operation.

2. The method of claim 1, wherein the operation includes modifying data at the local computer.

3. The method of claim 1, wherein the reverse forwarded socket connection binds an endpoint at the remote computer with the local computer.

4. The method of claim 3, wherein the binding of the reverse forwarded socket is based on at least one or a transmission control protocol-Internet protocol (TCPIP) port, a Unix filename, or a Unix socket.

5. The method of claim 1, further comprising:
receiving a third command that was sent from a second remote computer via a second reverse forwarded socket connection that binds the local computer to the second remote computer;
establishing a second program development environment uniquely associated with the second remote computer;
receiving a fourth command associated with the second program development environment via the second reverse forwarded socket connection;
executing the second command at the local computer; and
providing data to the second remote computer based on the execution of the second command.

6. The method of claim 5, wherein the binding of the local computer to the second remote computer is based on at least one of a transmission control protocol-Internet protocol (TCPIP) port, a Unix filename, or a Unix socket.

7. The method of claim 5, wherein the first remote computer executes instructions of a first type of operating system and the second remote computer executes instructions of a second type of operating system.

8. The method of claim 5, wherein the second reverse forwarded socket connection is established without provisioning the second remote computer with program code configured to allow the second computer to send the third command and the fourth command to the local computer.

9. The method of claim 1, wherein the reverse forwarded socket connection is established without provisioning the first remote computer with program code configured to allow the first computer to send the first command and the second command to the local computer.

10. A non-transitory computer-readable storage medium having embodied thereon instructions executable by one or more processors perform a method comprising:
sending a communication from a local computer to a first remote computer via a first communication connection;
establishing a reverse forwarded socket connection with the first remote computer based on data received from the first remote computer in response to the first remote computer receiving the communication from the local computer;
receiving a first command that was sent from the first remote computer via the reverse forwarded socket connection;
instantiating a program development environment associated with the first remote computer, in response to the first command;
receiving a second command associated with the program development environment via the reverse forwarded socket connection, the second command received from the first remote computer;
performing an operation according to the second command; and
providing data to the first remote computer based on the performance of the operation.

11. The non-transitory computer-readable storage medium of claim 10, wherein the operation includes modifying data at the local computer.

12. The non-transitory computer-readable storage medium of claim 10, wherein the reverse forwarded socket connection binds an endpoint at the remote computer with the local computer.

13. The non-transitory computer-readable storage medium of claim 12, wherein the binding of the reverse forwarded socket is based on at least one or a transmission control protocol-Internet protocol (TCPIP) port, a Unix filename, or a Unix socket.

14. The non-transitory computer-readable storage medium of claim 10, wherein the one or more processors execute the instructions to:
receive a third command that was sent from a second remote computer via a second reverse forwarded socket connection that binds the local computer to the second remote computer; establishing a second program development environment uniquely associated with the second remote computer;
receive a fourth command associated with the second program development environment via the second reverse forwarded socket connection;
execute the second command at the local computer; and
provide data to the second remote computer based on the execution of the second command.

15. The non-transitory computer-readable storage medium of claim 14, wherein the binding of the local computer to the second remote computer is based on at least one of a transmission control protocol-Internet protocol (TCPIP) port, a Unix filename, or a Unix socket.

16. The non-transitory computer-readable storage medium of claim 14, wherein the first remote computer executes instructions of a first type of operating system and the second remote computer executes instructions of a second type of operating system.

17. The non-transitory computer-readable storage medium of claim 14, wherein the second reverse forwarded socket connection is established without provisioning the second remote computer with program code configured to allow the second computer to send the third command and the fourth command to the local computer.

18. The non-transitory computer-readable storage medium of claim 10, wherein the reverse forwarded socket connection is established without provisioning the first remote computer with program code configured to allow the first computer to send the first command and the second command to the local computer.

19. An apparatus comprising:
a memory; and
a processor of a local computer that executes instructions out of the memory to:
send a communication to a first remote computer via a first communication connection;
establish a reverse forwarded socket connection with the first remote computer based on data received from the first remote computer in response to the first remote computer receiving the communication;
receive a first command that was sent from the first remote computer via the reverse forwarded socket connection;
instantiate a program development environment associated with the first remote computer, in response to the first command;
receive a second command associated with the program development environment via the reverse forwarded socket connection, the second command received from the first remote computer;
perform an operation according to the second command; and
provide data to the first remote computer based on the performance of the operation.

20. The apparatus of claim 19, wherein the operation includes modifying data at the local computer.
